(19) United States
(12) Patent Application Publication
(10) Pub. No.: US 2009/0009304 A1
(43) Pub. Date: Jan. 8, 2009

(54) Testing Apparatus for Vehicles and Trailers

(76) Inventor: Claude Lacasse, (US)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/102,461

(22) Filed: Apr. 14, 2008

(30) Foreign Application Priority Data
Apr. 13, 2007 (CA) 2,584,902

(51) Int. Cl. G08B 21/00

(52) U.S. Cl. 340/431

(57) ABSTRACT

A portable testing apparatus for testing the electrical systems and pneumatic systems of vehicles and trailers is provided. The apparatus can be alternatively connected to a vehicle or to a trailer. When connected thereto, a power supply in the testing apparatus provides electrical power to energize and test the various electrical systems thereof and a compressed air supply, also located in the testing apparatus, provides compressed air to feed and test the various pneumatic systems thereof. The testing apparatus is also generally equipped with indicator lights to provide visual indication of the proper functioning of a particular electrical circuit. Similarly, the testing apparatus is also generally equipped with pressure gauges to indicate the amount of pressure in a given pneumatic system and to detect leaks if any. The testing apparatus may also comprise a ground testing circuit for verifying that the vehicle or the trailer is correctly grounded electrically.

### CROSS-REFERENCE TO RELATED APPLICATIONS

The present invention claims the benefits of priority of commonly assigned Canadian Patent Application No. 2,584,902, entitled “Testing Apparatus for Vehicles and Trailers” and filed on Apr. 13, 2007, at the Canadian Intellectual Property Office.

### FIELD OF THE INVENTION

The present invention generally relates to testing units, devices and apparatuses for vehicles and trailers. More particularly, the present invention relates to testing units, devices and apparatuses generally adapted to test the electrical systems and pneumatic systems of such vehicles and trailers.

### BACKGROUND OF THE INVENTION

It is common practice for transport companies, certain commercial establishments, manufacturing plants, dealerships and the like, to own a fleet of vehicles and/or trailers which can be used, for example, to deliver the manufactured goods or which can be for sale. In order to guarantee the proper functioning of the electrical and pneumatic systems of the vehicles and/or trailers, it is generally necessary to test each of them on a regular basis.

Over the years, mechanics have developed various systems to correctly and efficiently test the pneumatic and electrical systems of vehicles and trailers but many of these test procedures require two men. As such, the cost of frequent inspections for vehicles and trailers has greatly increased in some cases, therefore putting the drivers, other motorists and property at risk as fewer inspections and tests are undertaken.

Heretofore a single mechanic would have difficulty in checking, for example, the pneumatic and hydraulic brake system beneath the vehicle while holding the brake pedal depressed and would likewise have difficulty in observing the brake lights at the rear of the tractor-trailer, car, truck, or bus from a position inside the cab of the vehicle. In addition, it has been difficult in the past to check the electrical light circuits of a trailer if unattached from a tractor because power must be supplied to the trailer electrical circuitry for a visual inspection. Similarly, it has been very difficult to check the pneumatic brake system or the pneumatic suspension system of a trailer if the trailer is not attached to a tractor because the trailer generally does not have the ability to generate and control compressed air for the pneumatic system. Moreover, it has been difficult to isolate the source of electrical and pneumatic problems as being in the tractor, the trailer, or the tractor-trailer.

There is therefore a need for a relatively portable apparatus which carries a substantially autonomous power supply or other source of electrical energy and a compressed air supply, such that the apparatus is being capable of being brought into operative position with respect to any one of a group of vehicles or trailers for appropriate testing and is reducing the time needed to carry out such tests by a single operator.

### OBJECTS OF THE INVENTION

A main object of the present invention is to provide a testing apparatus which can test the electrical systems and the pneumatic systems of vehicles and/or trailers.

Another object of the present invention is to provide a testing apparatus which generally comprises its own electrical power supply and its own compressed air supply.

Yet another object of the present invention is to provide a testing apparatus which is generally portable and which can allow a single person to test a vehicle and/or a trailer.

Still another object of the present invention is to provide a testing apparatus which generally reduces the time required for a single person to test the electrical and/or pneumatic systems of a vehicle and/or of a trailer.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

The aforesaid and other objectives of the present invention are realized by generally providing a novel testing apparatus for testing the electrical systems and pneumatics systems of different types of vehicles and more particularly of trailers destined to be attached to such vehicles.

The apparatus of the present invention is preferably embodied in a small portable truck or cart, preferably provided with a handle and wheels for easy movements in the courtyard where the vehicles and/or trailers are generally located. The apparatus therefore allows the person doing the tests to move easily from vehicle/trailer to vehicle/trailer.

Mechanically, the apparatus generally comprises a frame to which are mounted a handle and wheels. The frame further defines a housing into which are located an electrical power supply, generally but not exclusively in the form of a battery, for providing electric power to the tested electrical systems. Advantageously, the apparatus is further provided with a power converter for converting, as needed, the input and/or output voltage thereof. The power converter can also be used as a battery charger in order to recharge the battery.

Also located inside the housing is a compressed air supply for providing compressed air to the tested pneumatic systems. The compressed air supply is generally provided in the form of an air compressor coupled to an air tank. Preferably, the air tank is provided with a purge valve which is automatically activated when the testing apparatus is powered.

Though preferably an autonomous apparatus, the apparatus of the present invention may advantageously comprise electrical and pneumatic connectors for connecting the apparatus to external sources of electricity and/or compressed air. External electric and compressed air sources may be used, for example, the recharge the battery or to refill the tank when the apparatus is not in use. The external electric and compressed air sources may also serve as auxiliary sources should the apparatus be located in a garage or in a similar location. The present invention is not so limited.

In order to be able to visualise the proper functioning of the electrical systems and pneumatic systems as they are tested, the housing of the apparatus is provided with a control panel which is operatively connected to both the power supply and the compressed air supply via an electronic control module. Preferably, the control panel is provided with light indicators for each electrical system and with a pressure gauge for each pneumatic system. The control panel is also advantageously provided with an ammeter for measuring the current provided to each tested electrical system. Additionally, the control panel is provided with actuators such as, but not limited to, buttons and/or knobs, which are used to select particular electrical and/or pneumatic systems to test, to control the voltage and/or the pressure provided by the apparatus and to turn on or off certain other functionalities. It is therefore generally possible and even preferable to select individual electrical or pneumatic system to test in order to be able to pinpoint specific problems. For example, it may be possible to energize only the marking lights circuit of a trailer in order to test its proper functioning and/or to detect any burnt light. Moreover, the control module preferably provides that the indicator light associated with a specific electrical system, for example, the marking lights circuit, will light up only if a problem is detected therein. The person doing the test (hereinafter “the operator”) may also verify if the current provided to the tested electrical system is the nominal current or if there is a significant variation. Thus, the operator does not need to walk around the vehicle unless the panel indicates, via one of the indicator lights, and preferably via the ammeter, that a problem exists. Consequently, the time needed to test all the electrical systems of the vehicle/trailer is greatly reduced.

Also, according to an aspect of the present invention, the control module will provide a visual indication on the control panel if a problem exists with the electrical ground or mass of the tested vehicle or trailer. Preferably, but not exclusively, the control module will turn on all the indicating lights if a problem is detected with the electrical ground or mass. In another embodiment, a dedicated indicating light may be provided to provide a status of the electrical mass or ground. The present invention is not so limited.

Understandably, the manner in which the control module detects a default in an electrical system or with respect to the mass or ground can vary. For example, the control module can compare the current effectively provided with a nominal current. Accordingly, the control module would detect a default if the difference between the effective current and the nominal current is significant or beyond a specific threshold. Still, other way to detect default could be envisaged; the present invention is not so limited.

According to the invention, the control panel, via the control module, also allows to control the air pressure in a pneumatic system in order to verify the proper functioning of pneumatic systems such as air brakes and to verify the presence of leaks therein. Accordingly, the air compressor, the compressed air tank and all the valves are preferably electrically controlled via the control module. So configured, the operator of the testing apparatus can easily turn on or off the compressed air supply and/or can easily select the necessary pressure. Additionally, the control module of the apparatus is configured to provide several testing sequences for testing certain pneumatic systems such as antilock braking systems (ABS) provided on certain vehicles and/or trailers. For example, the testing circuitry could be configured to provide electrical current to the braking light circuit and compressed air to the pneumatic brake line as if the brakes were continuously applied. Additionally, the testing circuitry could be configured to provide electrical current to the braking light circuit and compressed air to the pneumatic brake line as if the brakes were periodically applied. The first sequence would generally allow the detection of leaks in the pneumatic brake line whereas the second sequence would generally allow the measurement of the displacement of the brake pistons. Understandably, other sequences could be possible.

Understandably, the control panel may comprise additional indicators such as, but not limited to, voltmeter and charge indicator. The invention is not so limited.

In order to speed up the testing process, the apparatus is provided with basic electrical and pneumatic connectors to which can be mounted multiple different adaptors for connecting the apparatus to any type of vehicles and/or trailers. The electrical and pneumatic connectors are understandably respectively in electric communication with the control module and in pneumatic communication with the compressed air tank.

Optionally, the apparatus may be provided with auxiliary testing devices for testing particular electric or pneumatic systems of for testing other systems. The present invention is not so limited.

As the skilled addressee would understand, the control module typically consists in a circuit board comprising all the connectors necessary to properly interface the different components of the apparatus, and processing means such as a central processing unit, a programmable micro-controller, an application-specific integrated circuit (“ASIC”) or a programmable integrated circuit (e.g. field programmable gate array “FPGA”). The control module could also comprise additional electronic components such as memory, analog to digital converter, digital-to-analog converter, comparator, etc.

Also, the apparatus may advantageously be provided with battery boosting cables, connected to the power supply (e.g. the battery), and with a pneumatic hose, connected to the compressed air supply (e.g. the air compressor), having a tire valve connector connected thereto. So equipped, the apparatus could be used as an autonomous battery boosting device and/or as a tire inflating station which can be easily moved around in a courtyard.

According to another aspect of the present invention, the apparatus may be provided with an electrical outlet into which can be plugged any electrical accessory such as a light, a radio, a power tool, etc.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a perspective view of an exemplary embodiment of the apparatus of the present invention;

FIG. 2 is an internal side view of the apparatus of FIG. 1.

FIG. 3 is a fractional front view of the control panel of the apparatus of FIG. 1.

FIG. 4 is a schematic view of the internal components of the apparatus of the present invention.

### DETAILED DESCRIPTION OF THE PREFERRED EMBODIMENT

A novel testing apparatus for vehicles and trailers will be described hereinafter. Although the invention is described in terms of specific illustrative embodiments, it is to be understood that the embodiments described herein are by way of example only and that the scope of the invention is not intended to be limited thereby.

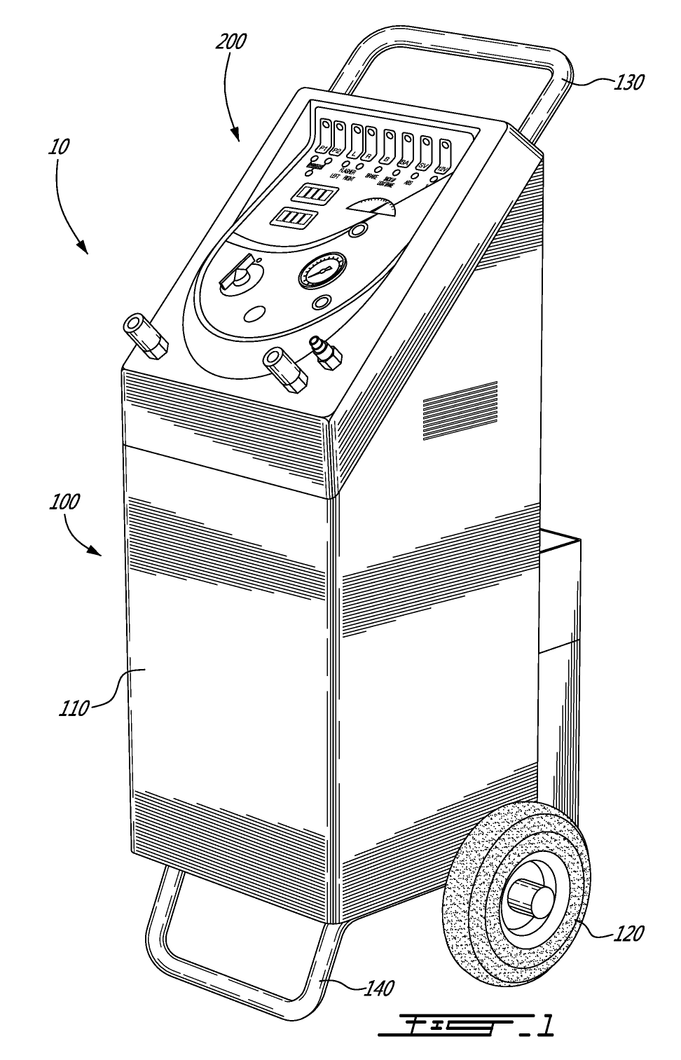

Referring first to FIG. 1, the mechanical construction of the apparatus 10 of the present invention is shown. The apparatus 10 is generally embodied into a portable truck or cart 100 into which are generally housed all the necessary components which shall be described below. The truck 100 generally comprises a housing 110 which defines an inner chamber 115 into which the testing equipments are preferably located. Generally mounted to the top portion of the housing 110 is a handle 130. Also mounted to the housing 110 but on lower portion thereof is a pair of wheels 120. Used in conjunction, the handle 130 and the wheels 120 assist the operator in moving the truck 100 from one vehicle/trailer to the next. Also, to prevent the truck 100 from falling over, the housing 110 is generally further provided with a support element 140 which is adapted to abut on the ground when the truck 100 is at rest.

As shown in FIG. 1, the front portion of the housing 110 is generally with a testing panel 200 wherein all the necessary buttons, knobs, gauges, meters, lights, etc. are disposed for easy access.

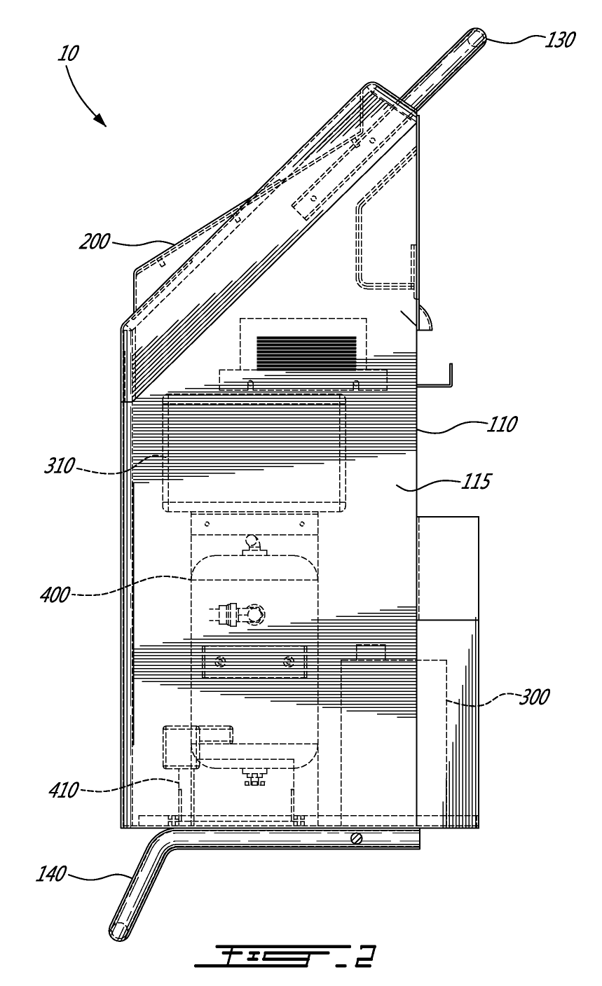

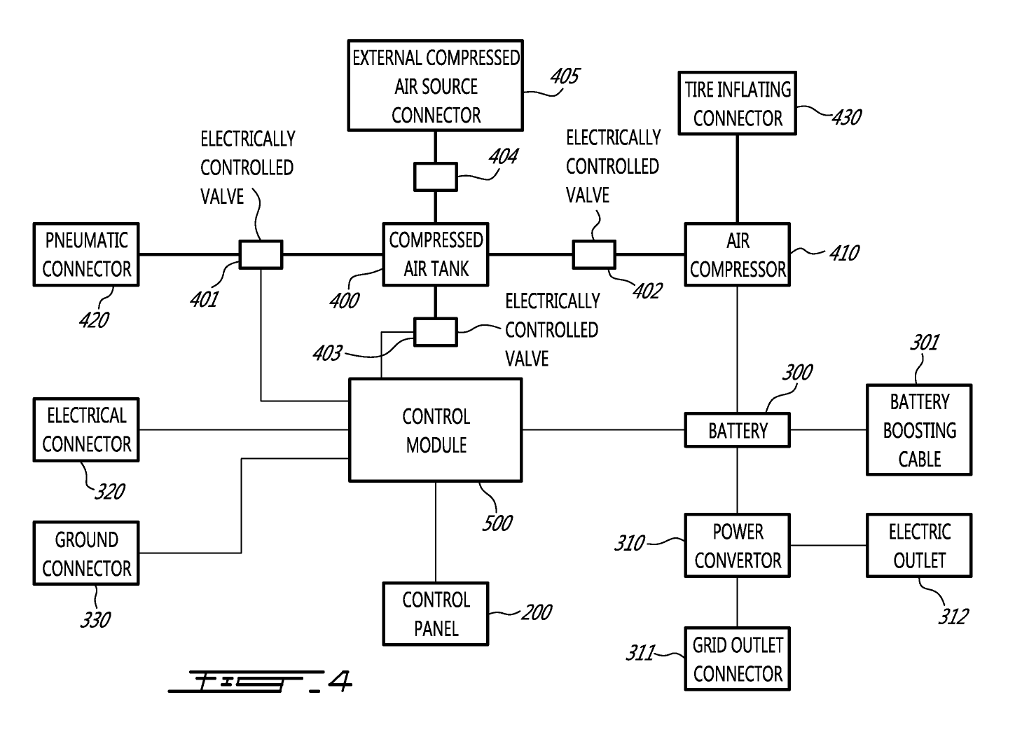

Referring now to FIG. 2, the housing 110 of the truck 100 defines a chamber 115 into which are located all the necessary testing equipments. For testing the electrical systems of the vehicle or trailer, the apparatus 10 is provided with at least a battery 300 to which can be plugged a power converter 310 for converting the battery voltage (i.e. approximately 12 volts) to another voltage (e.g. approximately 120 volts) and vice-versa. As schematically shown in FIG. 4, the power converter 310 can be provided with an electrical cord 311 which is adapted to be plugged in a power outlet. Thus, the power converter 310 can also act as a battery charger to recharge the battery 300 between tests and/or the power converter 310 can act as an auxiliary source of electrical power if the apparatus is located near an external power outlet into which the power converter 310 can be plugged.

Also located inside the housing 110 is a compressed air tank 400. The compressed air tank 400 is the source of compressed air which is used in the testing of the different pneumatic systems of the vehicle and/or trailer. Though it could be used alone, the air tank 400 is generally accompanied by an electric air compressor 410, generally connected to the battery 300 or the power converter 310. The air compressor 410 is in fluid communication with the air tank 400, via appropriate piping and valves 402 (see FIG. 4), so it can refill the tank 400 when the pressure therein falls below a certain threshold. Still, the air compressor 410 could be used as an auxiliary compressed air source if and/or when necessary. Understandably, the apparatus 10 could be provided with more than one compressed air tank 400 which would be fluidly connected together via appropriate piping and/or tubing.

As schematically depicted in FIG. 4 and in accordance with the preferred embodiment, the air tank 400 is also advantageously provided with an electrically actuated purge valve 403. Preferably, but not exclusively, the purge valve 403, operatively connected to the control module 500, would be actuated upon powering the apparatus 10 of the present invention. During its actuation, the purge valve 403 would purge the air tank 400 to remove any remaining gases.

As schematically depicted in FIG. 4, the apparatus 10 of the present invention could advantageously be provided with an inlet 405, fluidly connected to the compressed air tank 400, which could be connected to an external compressed air source via appropriate valve 404. So equipped, the apparatus 10 could be connected to an external compressed air source for refilling the tank 400 or for providing compressed air to the tested pneumatic systems.

As the person skilled in the art would understand, both the electrical power source 300/310 and the compressed air source 400/410 are operatively connected to the control panel 200, via the control module 500, which will now be described in more details.

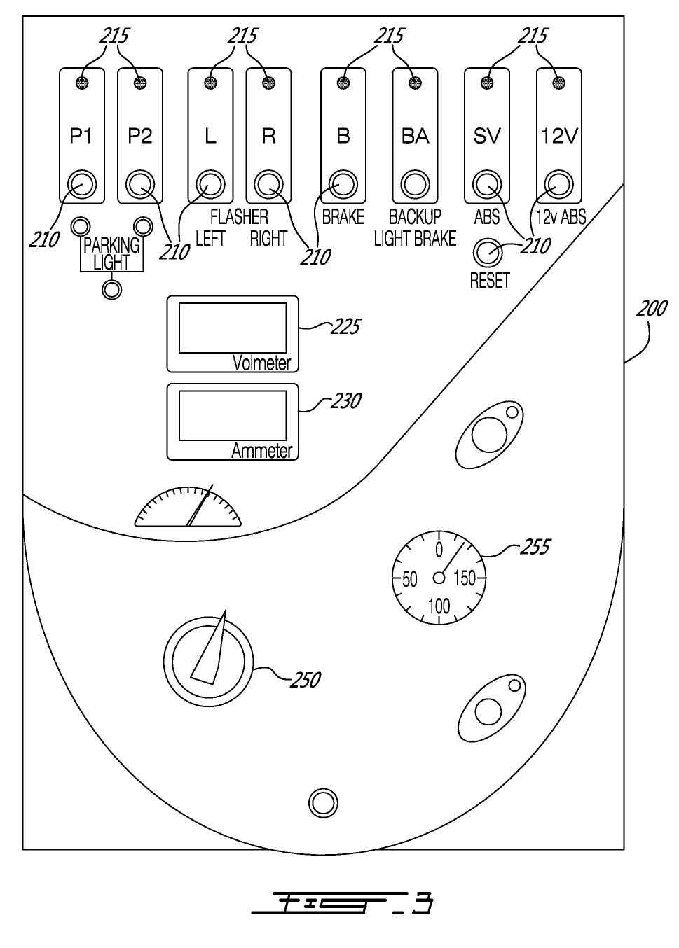

As depicted in FIG. 4, the control panel 200 shown in FIG. 3 is operatively connected, via the control module 500, to the electrical power source 300/310 and to the test connector 320 which will be connected to the vehicle/trailer electrical systems (e.g. brake light, marking lights, right turn light, left turn light, reverse light, parking light, auxiliary lights, electric brakes, etc.) via an appropriate adapter if necessary.

Referring now to FIG. 3, in order to provide efficient testing, the control panel is provided with selecting knobs, buttons, or other functionally equivalent actuating device 210, connected to the control module 500, which allows the operator to select which electrical system of the vehicle or trailer will be energized and thus tested. Associated with each specific electrical system is an indicator light 215. The indicator lights 215 are generally off unless the electrical system effectively selected and energized is not functioning properly (e.g. a short, a default, a burnt light, etc.). The control module 500, which controls the indicator lights 215, typically determines that an electrical system does not function properly by comparing the current effectively provided to the electrical system with a nominal current. Other ways to detect defaults can also be envisaged.

Thus, during testing, the operator only has to sequentially select each electrical system of the vehicle or trailer with the actuators 210 and to verify if any one of the indicator light turns on. If one of the indicator lights 215 does go up, the person can verify directly on the vehicle or trailer what or where the source of the problem is. If possible, corrective actions may be undertaken in situ. Still, unless a problem is detected by the activation of one of the lights 215, the operator does not have to visually inspect each electrical system.

In accordance with the foregoing, the control panel 200 is preferably provided with an ammeter 230, connected to the control module 500, to provide a visual indication of the current effectively provided to a tested electrical system. By comparing the measured current with a nominal current, the operator can confirm and/or refine the diagnostic of the apparatus 10.

For instance, if a light is burnt in a marking light circuit wherein the lights are connected in parallel, the burnt light may possibly go undetected but verification on the ammeter will show a variation with respect to the nominal current of the marking light circuit, thereby indicating a problem. However, since the number of lights provided on a vehicle or a trailer is likely to vary between manufacturers, it is generally preferable to know beforehand the nominal current that the properly functioning electrical systems of a certain model of vehicle trailer will normally consume. Also, as another example, if the lights of an electrical system (e.g. the marking lights) are connected in series, an open circuit (e.g. a burnt light, a severed wire) will be confirmed by measuring no current with the ammeter whereas a short circuit will be detected by measuring an excessive amount of current, generally limited by the electrical power source 300/310.

As the skilled addressee will understand, since each electrical system may have different parameters and configurations, the circuitry of the control panel 200 associated with each electrical system of the vehicle/trailer may differ from each other.

According to an aspect of the invention, the control module 500 will light up all the indicator lights 215 of the control panel 200 if a problem is detected with the ground or mass of the vehicle or trailer. This can be of real significance since ground or mass problem could cause one of the indicator lights 215 to turn on even though no real problem or malfunction exists. Hence, in order to solve ground or mass problem, the control module 500 is advantageously provided with a connector 330 (see FIG. 4) which is adapted to be connected to the ground or to the mass.

Since the apparatus 10 is preferably an autonomous apparatus, the control panel 200 is preferably equipped with a voltage indicating meter 225 which is adapted to display the voltage level of the battery 300. Hence, if the voltage level is below a certain threshold, the operator can bring back the apparatus 10 near an electrical outlet into which the battery charger/power converter 310 can be plugged via the power cord and outlet connector 311. Advantageously, the control panel 200 is provided with a charge level meter for indicating the advancement of the charging process.

In order to control the compressed air provided by the apparatus 10, the control panel 200 is provided with an actuator 250 operatively connected to an electrically controlled valve 401 via the control module 500. The control panel 200 is also preferably provided with a pressure gauge 255 for indicating the actual pressure provided thereby.

Though only one set of actuator 250 and pressure gauge 255 is shown, it is to be understood that a set of actuator 250 and pressure gauge 255 could be provided for each pneumatic system of the vehicle or trailer; the present invention is not so limited.

Once the pneumatic hoses are connected to the vehicle or the trailer, the valve 401 can be opened to allow the compressed air to flow trough the pneumatic systems to be tested. Whereas the diagnostic of the functioning of the electrical systems was done via the indicator lights, in the case of the pneumatic systems, the diagnostic is generally effected by monitoring the pressure indicated by the pressure gauge or gauges 255 even though some human manipulations may be required.

In the case of pneumatic suspension systems, the test generally consists in providing a certain amount of pressure to the pneumatic lines of the suspension and then monitors the pressure gauge 255 on the control panel 200 to see if the pressure indicated thereon varies. If the indicated pressure does vary, the operator may suspect the presence of a leak in the pneumatic system. The operator may then initiate visual (e.g. with the use of soapy water) and even auditory inspection of the pneumatic lines in order to localize and, if possible, repair the leak.

In the case of typical pneumatic brake systems, since the brakes are generally activated by default when no pressure is provided, the test generally consists in providing the necessary pressure to unlock the brakes and to verify if the wheels are indeed free to rotate when the necessary pressure is applied. If the brakes are not unlocked when the necessary pressure is provided, then the operator can readjust them. Also, the operator may additionally verify if the brakes are unlocked by a pressure lower than the necessary one. If the brakes are unlocked by a lower pressure, the person doing the test can readjust them.

Since more and more vehicles and trailers are now provided with antilock braking system (“ABS”), the control module 500 of the apparatus 10 of the present invention can be also advantageously configured to provide testing sequences for testing the proper functioning of these ABS brakes. Preferably, the control module 500 supports several testing sequences.

For example, in a first test, the control module 500 would turn on the brake light circuit and pressurize the pressure line of the air brakes of the vehicle/trailer. During this first test, the control module 500 would also typically energize the ABS controlling computer of the vehicle/trailer. This first test generally allows the operator to verify if the air brakes of the vehicle/trailer function properly (e.g. proper air pressure to unlock the brakes).

In a second test, the control module 500 would periodically turn on and off the brake light circuit and simultaneously periodically pressurize and depressurize the pressure line of the brake. The length of the period could be pre-programmed into the control module 500 (e.g. 10 seconds on, 10 seconds off) or selectable by the operator. Preferably, the test would go on until cancelled or stopped by the operator. This second test would allow the operator to go near the brakes and verify if they function properly and verify the displacement of the brake pistons. During this second test, the control module 500 would typically also energize the ABS controlling computer of the vehicle/trailer.

In a third test, the control module 500 would send a signal to the computer controlling the ABS brakes instructing the computer to periodically activate and deactivate the solenoids of the ABS brakes. As for the second test, the period could be pre-programmed in the control module 500 (e.g. 10 seconds on, 10 seconds off) or selectable by the operator. As for the second test, the third test would preferably go on until cancelled or stopped by the operator. This third test would allow the operator to verify the proper functioning of the solenoids of the ABS brakes.

Understandably, the aforesaid testing procedures are for exemplary purposes only. Hence, different electric and/or pneumatic systems may require different testing procedures; the present is therefore not limited to any testing procedures.

As the skilled addressee will understand, the control module 500 of the apparatus 10 of the present invention typically comprises an electronic circuit board having thereon processing means such as, but not limited to, a central processing unit (“CPU”), a programmable micro-controller, an application specific integrated circuit (“ASIC”) or a programmable integrated circuit (e.g. a field programmable gate array (“FPGA”). The control module 500 also comprises all the necessary electronic components such as memory, analog to digital converter, digital-to-analog converter, comparator, etc. The control module 500 also comprises all the connectors to properly interface the components (e.g. control panel 200, electric connector 320, valve 401, etc.) connected thereto.

Advantageously, the apparatus 10 may further be provided with an electrical outlet 312 (see FIG. 4), generally connected to the power converter 310, into which electrical accessories such as, but not limited to, portable light, radio and power tool, may be plugged. Additionally, the apparatus 10 could be provided with battery boosting cables 301 in order to use the apparatus 10 as a mobile battery boosting station. Furthermore, the present apparatus 10 could also be used as a mobile tire inflating station via the pneumatic testing equipment and appropriate tire valve coupling 430. Accordingly, the apparatus 10 of the present invention could be used both as a mobile testing device and as a mobile battery boosting and tire inflating device.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. An apparatus for testing electrical systems and/or pneumatic systems of a vehicle and/or a trailer, said apparatus comprising:
a. a frame;
b. a control module;
c. an electrical power source mounted to said frame and operatively connected to said control module;
d. a compressed air source mounted to said frame and operatively connected to said control module;
e. a control panel mounted to said frame and operatively connected to said control module, said control panel comprising an indicating light for at each electrical system of said vehicle and/or a trailer;
f. at least one electrical connector in electric communication with said control module via an electric cable;
g. at least one pneumatic coupling in pneumatic communication with said compressed air source via pneumatic tubing;
wherein said control module is configured to activate said indicator light associated with said electrical system if a default is detected in said electrical system.

2. An apparatus as claimed in claim 1, wherein said control module is adapted to activate all of said indicator lights if a default is detected with respect the grounding of said vehicle and/or trailer.

3. An apparatus as claimed in claim 1, wherein said frame comprises a handle mounted thereto and a pair of wheel pivotally mounted thereto.

4. An apparatus as claimed in claim 1, wherein said electrical power source comprises a battery.

5. An apparatus as claimed in claim 1, wherein said electrical power source comprises a battery and an electrical power converter.

6. An apparatus as claimed in claim 1, wherein said compressed air source comprises a compressed air tank.

7. An apparatus as claimed in claim 1, wherein said compressed air source comprises a compressed air tank and an electrical air compressor.

8. An apparatus as claimed in claim 1, wherein said control panel further comprises actuating means, connected to said control module, for selectively energizing each of said electrical systems of said vehicle and/or trailer.

9. An apparatus as claimed in claim 8, wherein said control panel further comprises an ammeter, connected to said control module, for measuring the current provided to said selected electrical system.

10. An apparatus as claimed in claim 1, further comprising an electrically controlled valve fluidly connected to said compressed air source and operatively connected to said control module for controlling the pressure provided by said compressed air source.

11. An apparatus as claimed in claim 10, wherein said control panel further comprises a pressure gauge, fluidly connected to said compressed air source, for providing visual indication of the pressure provided by said compressed air source.

12. An apparatus as claimed in claim 5, wherein said apparatus further comprises an electrical outlet connected to said electrical power converter for supplying electrical power to an electrical device.

13. An apparatus as claimed in claim 5, wherein said electrical power converter is adapted to recharge said battery.
